(19) United States
(12) Patent Application Publication
(10) Pub. No.: US 2006/0147843 A1
(43) Pub. Date: Jul. 6, 2006

(54) Fabrication process for ultra high density optical disc

(75) Inventor: Chien-Yang Chen, Hsinchu County (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/082,768

(22) Filed: Mar. 18, 2005

(30) Foreign Application Priority Data
Dec. 23, 2004 (TW) 93140201

(51) Int. Cl. G03C 5/00

(52) U.S. Cl. 430/321; 430/311; 430/322; 430/323; 430/324

(57) ABSTRACT

A method for fabricating ultra high density optical discs is disclosed, which comprises the steps of: (a) providing a substrate; (b) coating a photoresist on the substrate; (c) forming patterns on the photoresist by irradiating the same with a light source; (d) developing the photoresist for enabling the photoresist with patterns to be resided on the substrate; (e) dry etching the substrate for forming protrusions at the positions of the substrate corresponding to the patterns while generating apertures on the substrate; (f) removing the photoresist from the substrate completely; (g) placing the substrate on a fixture; (h) evenly coating an ultra-violet (UV) resin on the substrate while covering the apertures thereof; (i) curing the UV resin by irradiating the same with an UV light; (j) attaching a base panel onto the cured UV resin and then separating the cured UV resin from the apertures of the substrate; (k) coating a metal layer on the cured UV resin; (l) coating a protective layer on the metal layer.

### 1. FIELD OF THE INVENTION

The present invention relates to a method for fabricating ultra high density optical discs, and more particularly, to a method for fabricating ultra high density optical discs capable of increasing the manufacturing quality by a molding technique.

### 2. BACKGROUND OF THE INVENTION

Nowadays, the most common method for mass producing replicate optical discs from a master optical disc is injection molding. However, owing to the development and requirement of high density optical disc for large volume storage, the information pit and tracking formed on a high density optical disc is getting smaller and smaller. Taking a typical optical disc of 12 inches in diameter for example, each information pits formed thereon is smaller than 100 nm as the storage volume thereof exceeds 100 GB. As such, while producing a replicate optical disc by a conventional injection molding method, it is almost a certainty that information loss will occur over a substantial areas at the edge of the replicate optical disc, which causes unwanted cracking sounds to be generated in audio discs and mosaic images or discontinuity of images to be generated in video discs.

In addition, to replicate an optical disc by injection molding, it is required to manufacture a mold first that the process of making the mold is costly and time consuming, further that, the mold as well as the mother disc are subjecting to several high pressure and high temperature processes for replicating optical discs that causes the mold and the mother disc to have a short lifespan.

In a prior art technique disclosed in U.S. Pat. No. 4,961,884, entitled “Process For Producing Substrate of Optical Disc” and related to an injection molding process for producing a substrate of an optical disc, the molten molding resin is injected into the cavity of a mold through a signal opening thereof that causes the drawback of information loss to occur over a substantial areas at the edge of the replicate optical disc as mentioned hereinbefore and thus can not be applied for producing high density optical discs.

In another prior art technique disclosed in U.S. Pat. No. 4,980,262, entitled “Producing A Replicate Video Disc By A Method of Photographic Contact Printing” and related to a photographic contacting printing process for mass producing replicate video discs from a master disc, the replicate video disc is defected due to the presence of dust, dirt, etc., that are almost impossible to completely eliminate in any practical manner.

As a corollary to the abovementioned shortcomings, it is intended by the present invention to provide a method capable of fabricating ultra high density optical discs.

### SUMMARY OF THE INVENTION

It is the primary object of the invention to provide a method for fabricating ultra high density optical discs, which is capable of overcoming the information loss occurring at the edge of the replicate optical disc while it is produced by conventional injection molding and thus increasing the quality of the replicate optical disc by duplicating more information pits without loss.

It is another object of the invention to provide a method for fabricating ultra high density optical discs, by which a mold is manufactured out of a mother disc using a molding technique for greatly reducing the manufacturing cost and time thereof, and consequently, increasing the lifespan of the mother disc by avoiding the same to be subjected to a high-temperature high-pressure process while replicating.

To achieve the above objects, the present invention provides a method for fabricating ultra high density optical discs, comprising the steps of:
(a) providing a substrate;
(b) coating a photoresist on the substrate; wherein, preferably, the photoresist is a negative photoresist
(c) forming information pits on the photoresist by irradiating the same with a light source; wherein the light source can be selected from the group consisting of a leaser beam, an electron beam, an ion beam, a tip of probe machining, and a laser-emitting fiber-optic probe.
(d) developing the photoresist for enabling the portion of photoresist with information pits to be resided on the substrate;
(e) dry etching the substrate for forming protrusions at the positions of the substrate corresponding to the information pits while generating apertures on the substrate; wherein the dry etching can be perform by a means selected from the group consisting of Inductive-Coupled Plasma (ICP) etching and Reactive Ion Etching (RIE).
(f) removing the photoresist from the substrate completely;
(g) placing the substrate on a fixture;
(h) evenly coating an ultra-violet (UV) resin on the substrate while covering the apertures thereof; wherein the coating can be perform by a means selected from the group consisting of spin coating and drip coating;
(i) curing the UV resin by irradiating the same with an UV light;
(j) attaching a base panel onto the cured UV resin and then separating the cured UV resin from the apertures of the substrate;
(k) coating a metal layer on the cured UV resin;
(l) coating a protective layer on the metal layer.

In a preferred embodiment of the invention, a negative photoresist and a method of dry etching is used for manufacturing a mold out of a mother disc, wherein the mold is not restricted to be a conventional nickel mold, but also can be a silicon wafer or a glass substrate. Moreover, an UV resin used as the material of producing optical discs out of the mold is being coated on the mold by spin coating, by which not only a thin, uniform film of large area can be achieved by controlling the rotation speed of the spin coating, but also an optical disc with preferred quality can be acquired by controlling the dropping position of the UV resin on the substrate and the rotation speed of the spin coating.

From the above description, it is noted that the present invention has advantages list as following:
(1) It is easy to manufacture a mold out of a mother disc and the cost thereof is low.
(2) No high temperature and high pressure is required during the process of replicating optical discs.
(3) The quality of replicate optical disc is comparably higher such that the yield is high.
(4) It is easy to control the thickness and uniformity of the replicate optical discs.

Other objects and features of the invention will be pointed out or will occur to those skilled in the art from a reading of the following specification in conjunction with the accompanying drawings.

### BRIEF DESCRIPTION OF THE DRAWINGS

FIG. 1 is a sectional view of a substrate provided for the method for fabricating ultra high density optical discs according to the present invention;

FIG. 2 is a schematic view showing the coating of a photoresist onto the substrate of the present invention;

FIG. 3 is a schematic view showing the process of exposing the photoresist to a light source according to the present invention;

FIG. 4 is a schematic view showing the process of developing the photoresist according to the present invention;

FIG. 5 is a schematic view showing the process of dry etching the substrate according to the present invention;

FIG. 6 is a schematic view showing the photoresist is removed completely from the substrate according to the present invention;

FIG. 7 is a schematic view showing that the substrate is being hold by a fixture according to the present invention;

FIG. 8 is a schematic view showing the coating of a UV resin on the etched substrate according to the present invention;

FIG. 9 is a schematic view showing the curing of the UV resin according to the present invention;

FIG. 10 is a schematic view showing the attaching of a base panel onto the UV resin according to the present invention;

FIG. 11 is a schematic view showing the demolding of the UV resin from the substrate according top the present invention;

FIG. 12 is a schematic view showing the process of coating a metal layer on the UV resin.

### DESCRIPTION OF THE PREFERRED EMBODIMENT

or your esteemed members of reviewing committee to further understand and recognize the fulfilled functions and structural characteristics of the invention, several preferable embodiments cooperating with detailed description are presented as the follows.

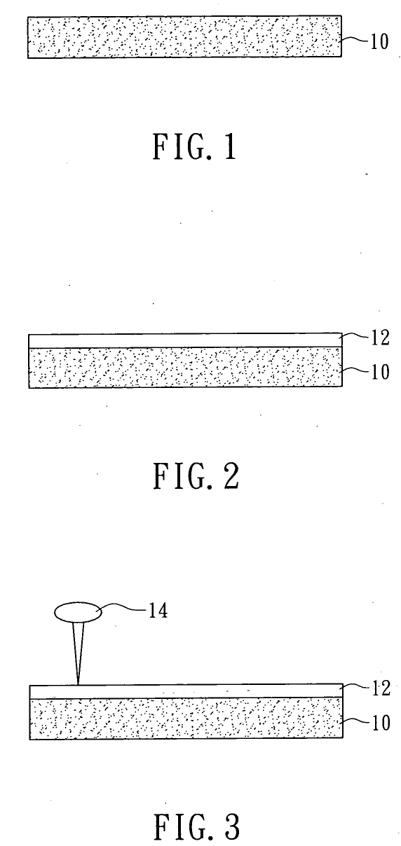

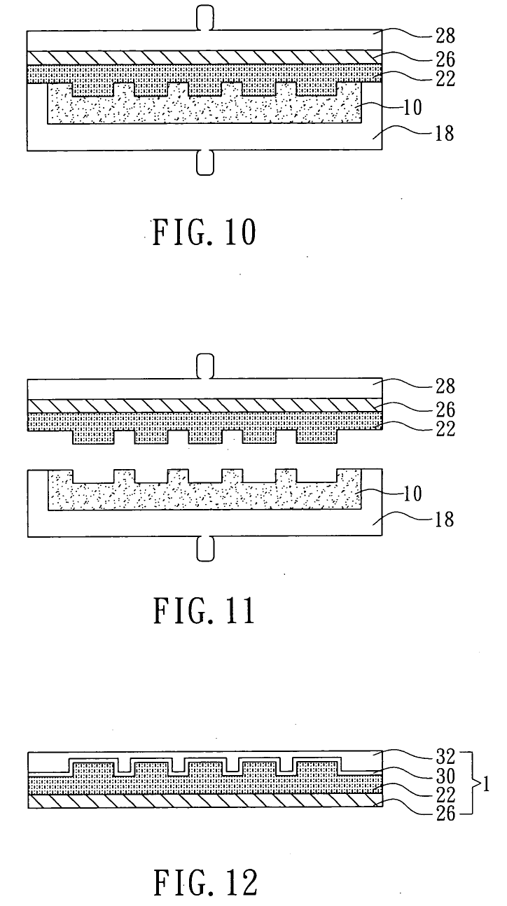

Please refer to FIG. 1˜FIG. 10, which are diagrams depicting the flowchart of a method for fabricating ultra high density optical discs according to the present invention. As the step shown in FIG. 1, a substrate 10 is provided that can be made of a metal, a glass or a silicon wafer. Conventionally, a glass substrate is being used as the substrate 10 since a laser beam is commonly used as the light source to irradiate the substrate for patterning. However, to manufacturing an optical disc with information pits of ultra high density, it is necessary to use an electron beam for replacing the laser beam. Thus, the substrate 10 must be made of a conductive material like silicon wafer or metal so as to avoid charging effect.

In the step shown in FIG. 2, a photoresist 12 is coated on the substrate 10, in addition, the photoresist 12 is a negative photoresist so that the negative photoresist 12 will remain on the substrate 10 wherever it is exposed since the exposure to the light causes the negative resist to become polymerized, and more difficult to dissolve.

After the photoresist 12 is coated, it is exposed to a light source 14 for patterning with respect to information pits, as seen in FIG. 3. The light source 14 can be selected from the group consisting of a leaser beam, an electron beam, an ion beam, a tip of probe machining, and a laser-emitting fiber-optic probe. If an electron beam or an ion beam is employed as the light source 14 in a manufacturing device, optical discs of different specifications can be manufactured out of the same manufacturing device since the size of the focus point and the interval between exposure tracks can be adjusted at will.

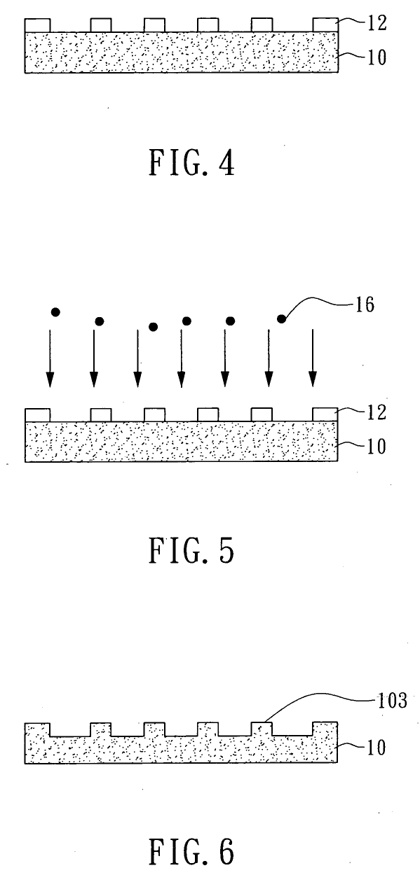

In the step shown in FIG. 4, the portion of the patterned photoresist 12 is kept on the substrate 10 while removing those not patterned by the process of developing. That is, the pits containing information are being reserved on the surface of the substrate 10.

Following, in FIG. 5, the substrate 10 is subjected to a dry etching process for transforming the patterns defined by the remaining photoresist 12 onto the substrate 10. In a preferred embodiment shown in FIG. 5, the agent of the dry etching process is plasma 16. Preferably, the dry etching can be perform by a means selected from the group consisting of Inductive-Coupled Plasma (ICP) etching and Reactive Ion Etching (RIE). Nevertheless, It is to be understood that the foregoing description is merely a disclosure of particular embodiments and is no way intended to limit the scope of the invention. Other possible modifications or means capable of transferring patterns onto the substrate 10 will be apparent to those skilled in the art and can be adopted by the present invention.

After the dry etching process, the remaining photoresist 12 is removed from the substrate 10 as seen in FIG. 6 such that a mold is formed. The mold is the substrate with a plurality of protrusions 103 arranged thereon, wherein each protrusion is related to a corresponding information pits and is similar to that of a mold formed by injection molding.

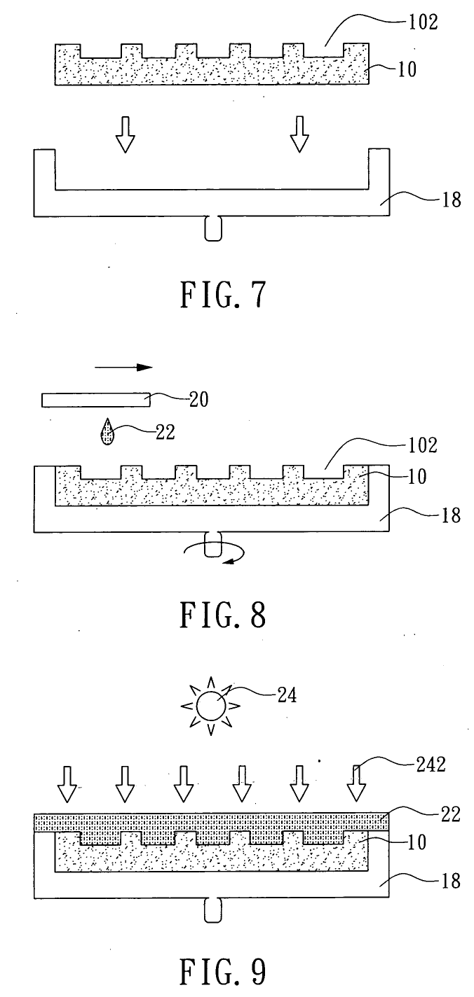

While the mold, i.e. the substrate 10, is formed, the processes of molding can start. The process starts from the step shown in FIG. 7 where the substrate 10 is being placed in a fixture 18 for fixing the substrate 10 by clamping, suction, or adhesive, etc. Moreover, the fixture is rotatable by itself or can be bring along to rotate by a rotary machine (not shown).

In the step shown in FIG. 8, the fixture 18 is activated to rotate while a robot arm 20 stretches out from a side of the fixture 18 progressively and drop an excess amount of UV resin on the surface of the substrate 10, in which the dropping of the UV resin 22 can be performed in section for ensuring the UV resin 22 to fill the apertures 102 of the substrate 10 evenly and completely.

After the UV resin 22 is coated on the substrate 10, the UV resin 22 is cured by irradiating the same with an UV light 242 discharging from a light source 24, as shown in FIG. 9. In the curing process of FIG. 9, the speed of producing replicate optical disc can be accelerated by reducing the curing time which can be achieved by minimizing the thickness of the UV resin layer 22, that is, the amount of UV resin 22 dropped on the substrate 10 is controlled to barely enough fill the apertures 102.

In FIG. 10, a process for thickening the replicate optical disc is performed after the curing process. As seen in FIG. 10, a base panel 26 with a surface coated with adhesive is fixed in a second fixture 28 and the second fixture 28 functions to attach the adhesive-coated surface of the base panel 28 to the cured UV resin 22. The thickening process can enable the total thickness of the replicate optical disc to conform to a specific specification and also can increase the mechanical strength of the replicate optical disc.

The demolding process is shown in FIG. 11, where the second fixture 28 moves away from the fixture 18 so as to enable the UV resin 22 to separate from the fixture 18 since the UV resin 22 is cured and adhered firmly on the base panel 26.

Finally, as shown in FIG. 12, a metal layer 30 is further coated on the UV resin 22. In a preferred embodiment of the invention, the metal layer 30 is coated by a method of sputtering deposition. Further, a protective layer 32 is coated on the metal layer 30 for increasing protection from abrasive and further increasing mechanical strength. Thus, a replicate optical disc 1 is achieved.

From the above description, the mold required in the fabrication method provided in the present invention is not only cheap and easy to make, but also have a longer lifespan since it is not subjected to a high-temperature and high-pressure process. In addition, it is easy to control the thickness and uniformity of the replicate optical discs such that the replicate optical discs can have comparably better quality and higher yield.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for fabricating ultra high density optical discs, comprising the steps of:
(a) providing a substrate;
(b) coating a photoresist on the substrate;
(c) forming patterns on the photoresist by irradiating the same with a light source;
(d) developing the photoresist for enabling the photoresist with patterns to be resided on the substrate;
(e) dry etching the substrate for forming protrusions at the positions of the substrate corresponding to the patterns while generating apertures on the substrate;
(f) removing the photoresist from the substrate completely;
(g) placing the substrate on a fixture;
(h) evenly coating an ultra-violet (UV) resin on the substrate while covering the apertures thereof;
(i) curing the UV resin by irradiating the same with an UV light;
(j) attaching a base panel onto the cured UV resin and then separating the cured UV resin from the apertures of the substrate;
(k) coating a metal layer on the cured UV resin;
(l) coating a protective layer on the metal layer.

2. The method of claim 1, wherein the substrate is made of glass.

3. The method of claim 1, wherein the substrate is made of a conductive material.

4. The method of claim 3, wherein the conductive material is a material selected from the group consisting of metal and silicon wafer.

5. The method of claim 1, wherein the photoresist is a negative photoresist.

6. The method of claim 1, wherein the light source is a energy source selected from the group consisting of a leaser beam, an electron beam, an ion beam, a tip of probe machining, and a laser-emitting fiber-optic probe.

7. The method of claim 1, wherein dry etching is perform by a means selected from the group consisting of Inductive-Coupled Plasma (ICP) etching and Reactive Ion Etching (RIE).

8. The method of claim 1, wherein the coating of the UV resin onto the substrate is perform by spin coating.

9. The method of claim 1, wherein the coating of the UV resin onto the substrate is performed by drip coating.

10. The method of claim 1, wherein the substrate is a transparent substrate.

11. The method of claim 1, wherein the substrate is made of polycarbonate (PC) resin.

12. The method of claim 1, wherein the coating of the metal layer is performed by a method of sputtering deposition.
